(19) United States
(12) Patent Application Publication
(10) Pub. No.: US 2025/0320882 A1
(43) Pub. Date: Oct. 16, 2025

(54) METHOD FOR CHECKING THE STATE OF A HYDRAULIC ACCUMULATOR

(71) Applicant: DEERE & COMPANY, MOLINE, IL (US)

(72) Inventors: MICHAEL MEID, WAGHAEUSEL (DE); THOMAS BUSOLD, BRUEHL (DE)

(21) Appl. No.: 19/086,856

(22) Filed: Mar. 21, 2025

(30) Foreign Application Priority Data
Apr. 11, 2024 (EP) 24169682.2

(51) Int. Cl. F15B 19/00

(52) U.S. Cl. CPC F15B 19/005; F15B 2201/505; F15B 2201/51

(57) ABSTRACT

A method for checking the state of a hydraulic accumulator having a fluid chamber, which communicates with a hydraulic system supplied with hydraulic fluid from a hydraulic reservoir by a motor-driven hydraulic pump, includes monitoring via a control unit a pressure drop in the hydraulic system in relation to a jump in the pressure curve, which is characteristic of reaching a fully relaxed state of the hydraulic accumulator, when the motor drive of the hydraulic pump is switched off, ascertaining via the control unit a hydraulic pressure corresponding to the jump in the pressure curve, calculating via the control unit a preload pressure exerted by the hydraulic accumulator by starting with the ascertained hydraulic pressure, and concluding via the control unit a malfunction of the hydraulic accumulator when the preload pressure does not reach a specified target value.

### CROSS-REFERENCE TO RELATED APPLICATIONS

This application claims priority to European Patent Application No. 24169682.2, filed Apr. 11, 2024, which is hereby incorporated by reference.

### FIELD OF THE DISCLOSURE

The disclosure relates to a method for checking the state of a hydraulic accumulator.

### BACKGROUND

Agricultural and forestry vehicles can have hydraulic circuits with accumulators for storing pressure.

### SUMMARY

The disclosure relates to a method for checking the state of a hydraulic accumulator, in which the hydraulic accumulator has a fluid chamber, which can be compressively preloaded in opposition to the resetting effect of a compression means for the reversible storage of hydraulic energy and which communicates with a hydraulic system supplied with hydraulic fluid from a hydraulic reservoir by a motor-driven hydraulic pump.

In agricultural and forestry vehicles, hydraulic accumulators serve, inter alia, for the redundant backup of the hydraulic supply for basic hydraulic functions, for example in the event of a functional impairment of a high pressure pump provided for the hydraulic supply. In addition to the operation of a hydraulic brake system or hydrostatic vehicle steering, the basic hydraulic functions may also relate, inter alia, to the hydraulic control of an actuating device for activating a gear-change point of a manual gearbox or the like comprised by the agricultural and forestry vehicle.

Hydraulic accumulators are known in various forms; however, they can have a fluid chamber, which can be compressively preloaded in opposition to the effect of a compression means and which serves for the reversible storage of hydraulic energy. In this regard, the hydraulic accumulator may be designed as a diaphragm accumulator, in which the compression means is formed by an elastic diaphragm made of metal or an elastomer, which, during the filling of the fluid chamber, can be deflected in opposition to the resetting effect of a compressible gas, generally nitrogen, located in a gas chamber. Instead of a diaphragm accumulator, this may also be a bladder accumulator or a piston accumulator.

If the hydraulic accumulator is used for the redundant backup of the hydraulic supply for basic hydraulic functions, for example in an agricultural and forestry vehicle, it is subject to more stringent requirements in terms of its failure-safety. This may be impaired in the event of a loss of function of the compression means (generally as a result of the compressible gas escaping due to a leak).

Therefore, the object of the present disclosure is to specify a method for checking the state of a hydraulic accumulator, by means of which a degradation of the energy storage capacity of the hydraulic accumulator can be detected promptly and reliably.

This object is achieved by a method for checking the state of a hydraulic accumulator having the features of one or more embodiments disclosed herein.

In the method according to the disclosure for checking the state of a hydraulic accumulator, the hydraulic accumulator has a fluid chamber, which can be pressurized in opposition to a resetting preload force of a compression means for the reversible storage of hydraulic energy and which communicates with a hydraulic system supplied with hydraulic fluid from a hydraulic reservoir by a motor-driven hydraulic pump, wherein it is provided that, when the motor drive of the hydraulic pump is switched off, a control device monitors a pressure drop in the hydraulic system in relation to a jump in the pressure curve, which is characteristic of reaching a fully relaxed state of the compression means, and ascertains a hydraulic pressure corresponding to the jump in the pressure curve, wherein, starting with the ascertained hydraulic pressure, a preload pressure exerted by the compression means is calculated in order to conclude a malfunction of the hydraulic accumulator if a specified target value is not reached.

The hydraulic pump is generally a pump having a fixed or adjustable delivery volume, which is part of a hydraulic system arranged in an agricultural or forestry vehicle and which serves for the hydraulic supply to one or more hydraulic consumers. The hydraulic pump is typically set in rotation via a gear drive by means of an internal combustion engine comprised by the vehicle. When the internal combustion engine is switched off, it continues to rotate slightly until it has come to a complete standstill. The hydraulic pump is then likewise at a standstill, so that it no longer delivers hydraulic fluid into the hydraulic system. The pressure drop which is then initiated provides the basis for the subsequent assessment of the functional state of the hydraulic accumulator. If the function of the compression means contained therein is impaired as a result of a degradation of the preload force, this is expressed through a comparatively low hydraulic pressure in the jump in the pressure curve. The target value which is specified and defined accordingly in this regard for a functional state of the compression means is found in corresponding information provided by the manufacturer of the hydraulic accumulator used and is in the order of magnitude of 12 bar in the types used for gear-change purposes in agricultural or forestry vehicles, which serve for the redundant backup of a hydraulic actuating device for activating a gear-change point of a manual gearbox or the like.

The hydraulic accumulator may be a diaphragm accumulator, in which the compression means is formed by an elastic diaphragm made of metal or an elastomer, which, during the filling of the fluid chamber, can be deflected in opposition to the resetting effect of a compressible gas, generally nitrogen, located in a gas chamber. However, it should be noted that the hydraulic accumulator may be of any design; in this regard, a bladder accumulator or a piston accumulator are also equally possible. A degradation of the preload force here generally occurs as a result of gas losses due to a leak.

It should also be noted that the use of the proposed method for state-checking is not restricted to agricultural or forestry vehicles; it may equally relate to a construction vehicle or a stationary application.

Advantageous developments of the method according to the disclosure are revealed in one or more embodiments disclosed herein.

Since the preload force exerted by the compression means, and therefore the position of the jump in the pressure curve, is temperature dependent, it can be advantageous if the hydraulic pressure corresponding to the jump in the pressure curve, or the preload pressure arising directly from this, is converted into a temperature-compensated preload pressure of the compression means by the control device and then compared with the specified target value for assessment of a possible malfunction of the hydraulic accumulator. The specification of the reference temperature takes place at a standardized room temperature of 20° C. here.

In a deviation from this, for the purposes of temperature compensation, it is also conceivable to adapt the specified target value accordingly or to carry out the comparison with the uncompensated preload pressure when defined temperature conditions are present.

Since the current temperature of the compressible gas in the hydraulic accumulator is generally unknown or can be detected with significant additional effort, it is possible that the current operating temperature of the hydraulic fluid located in the fluid chamber of the hydraulic accumulator is alternatively used by the control device to calculate the temperature-compensated preload pressure. This may take place on the basis of the current operating temperature of the hydraulic fluid in the hydraulic system and/or by evaluating the influences on the operating temperature arising from the current external or ambient temperature. The operating temperature of the hydraulic fluid ultimately represents an auxiliary variable here, which permits at least an indirect conclusion with regard to the current temperature of the compressible gas in the gas chamber of the hydraulic accumulator. In one example, this equates to the operating temperature of the hydraulic fluid.

In this respect, to improve the accuracy when estimating the current operating temperature of the hydraulic fluid located in the fluid chamber of the hydraulic accumulator, it is conceivable that, from a plurality of sensor devices which are distributed in the hydraulic system for the purpose of ascertaining the hydraulic pressure and/or detecting the operating temperature of the hydraulic fluid, the control device selects or uses those which are spatially nearest to the hydraulic accumulator or the fluid chamber thereof.

It is also possible that, through activation of a user interface, the control device induces the output of driver information indicating a malfunction of the hydraulic accumulator and/or the generation of an input indicating a malfunction of the hydraulic accumulator into a diagnostic system. This significantly simplifies the assessment as to whether maintenance or replacement of the hydraulic accumulator is required.

The above and other features will become apparent from the following detailed description and accompanying drawings.

### BRIEF DESCRIPTION OF THE DRAWINGS

The method according to the disclosure will be explained in more detail hereinafter on the basis of the appended drawings. In the drawings:

FIG. 1 shows a schematically illustrated arrangement for carrying out the method according to the disclosure for checking the state of a hydraulic accumulator in an agricultural tractor;

FIG. 2 shows an example embodiment, illustrated as a flow chart, of the method according to the disclosure for checking the state of a hydraulic accumulator; and

FIG. 3 shows a diagram in which the pressure-drop behavior of the hydraulic accumulator is reproduced to represent two different functional states.

### DETAILED DESCRIPTION

The embodiments or implementations disclosed in the above drawings and the following detailed description are not intended to be exhaustive or to limit the present disclosure to these embodiments or implementations.

The arrangement 12, which is found in an agricultural tractor 10, comprises a hydraulic accumulator 14 which may be acted upon by pressurized hydraulic fluid via a supply line 16.

For example, the hydraulic accumulator 14 has a fluid chamber 20, which can be compressively preloaded in opposition to the effect of a compression means 18 and which serves for the reversible storage of hydraulic energy. To this end, the fluid chamber 20 communicates with a hydraulic system 22 of the agricultural tractor 10 via the supply line 16, which hydraulic system is supplied with hydraulic fluid from a hydraulic reservoir 26 by a motor-driven hydraulic pump 24. In the present case, the hydraulic pump 24 is a pump with a fixed delivery volume or a fixed pump 28, which serves for the hydraulic supply to a hydraulic consumer 30. The hydraulic pump 24 is set in rotation here via a gear drive 32 by means of an internal combustion engine 34 comprised by the agricultural tractor 10.

By way of example, the hydraulic accumulator 14 is designed as a diaphragm accumulator 36, in which the compression means 18 is formed by an elastic diaphragm 38 made of metal or an elastomer, which, during the filling of the fluid chamber 20, can be deflected in opposition to the resetting effect of a compressible gas, in this case nitrogen, located in a gas chamber 40. Instead of a diaphragm accumulator 36, this may also be a bladder accumulator or a piston accumulator.

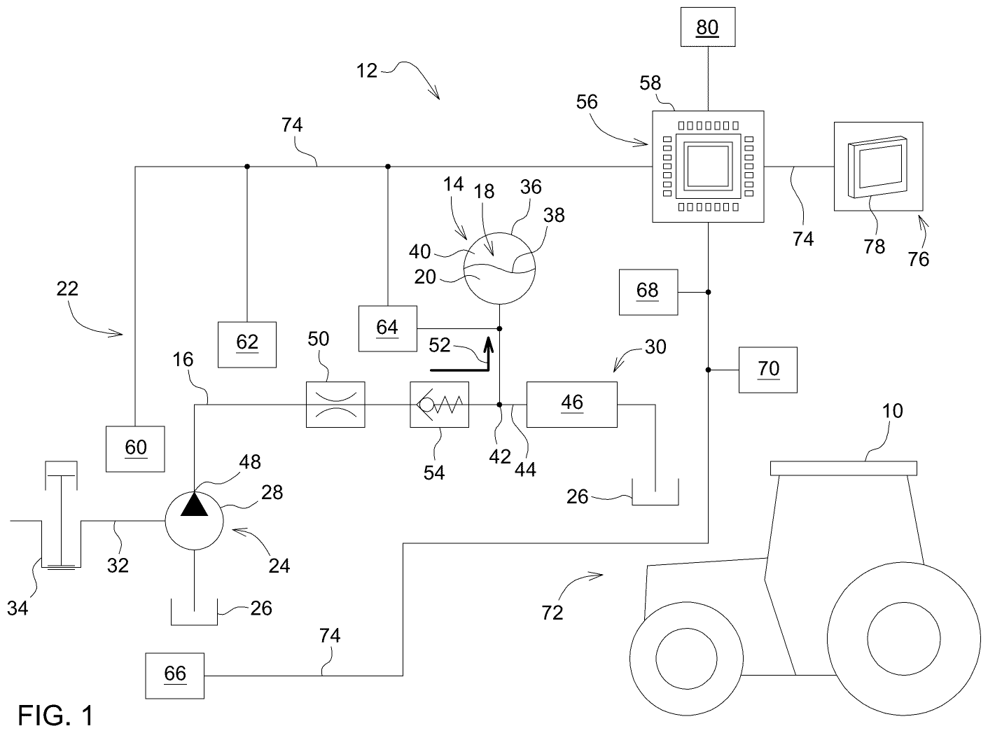

With reference to the structurally simplified illustration of the arrangement 12 in FIG. 1, the fluid chamber 20 of the hydraulic accumulator 14 communicates, on the one hand, with the supply line 16 coming from the hydraulic pump 24 and, on the other, with a feed line 44 for supplying the hydraulic consumer 30, here a hydraulic actuating device 46 for activating a gear-change point of a manual gearbox (not shown) comprised by the agricultural tractor 10, via a T-junction 42. A hydraulic diaphragm 50 is furthermore located in the supply line 16 between a delivery outlet 48 of the hydraulic pump 24 and the T-junction 42, followed by a non-return valve 54 which permits a flow in the filling direction 52 of the hydraulic accumulator 14.

In addition to an electronic control unit (ECU) 58, a control device 56 comprised by the arrangement 12 has a plurality of sensor devices 60, 62, 64, 66, 68 for monitoring the pressure and temperature conditions prevailing in the hydraulic system 22, which, in the present case, takes place by detecting a current operating temperature of the hydraulic fluid in the hydraulic system 22 or by ascertaining a hydraulic pressure p_sys prevailing therein. A further sensor device 70 serves to detect a current external or ambient temperature, for example within an engine compartment 72 surrounding the hydraulic accumulator 14. The sensor data generated here are passed to the control unit 58 via a CAN data bus 74 for evaluation. A user interface 76 enables driver information to be output via an integrated display 78.

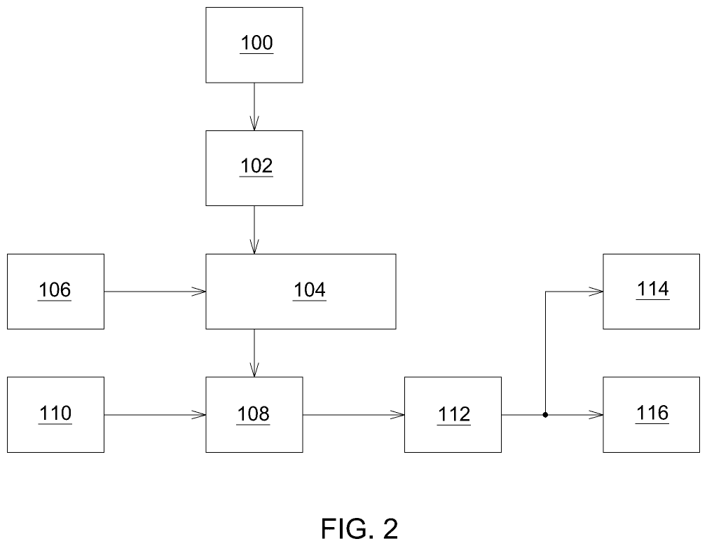

FIG. 2 shows the process of the method according to the disclosure, illustrated as a flow chart.

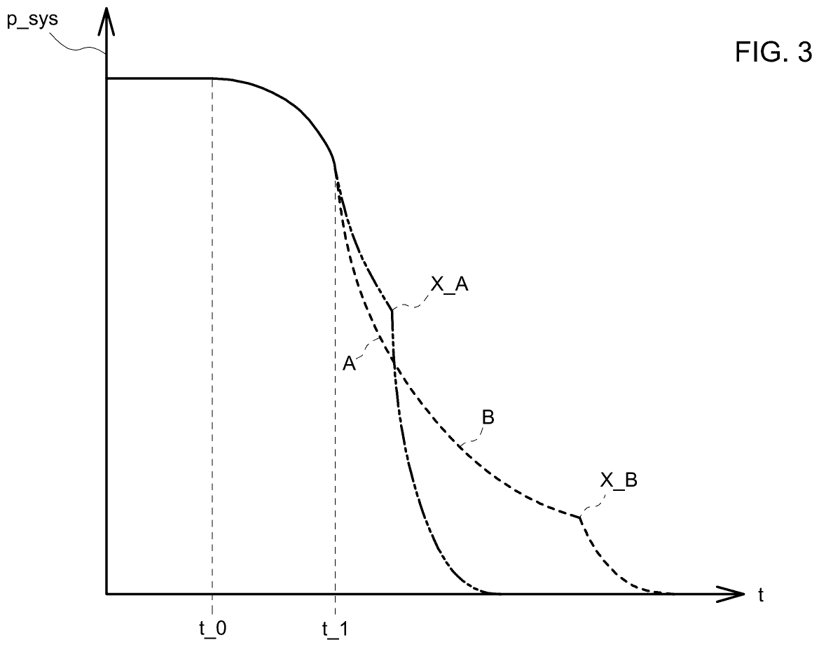

The method, which is stored in the control unit 58 as a corresponding program code, begins with the start-up of the agricultural tractor 10 in a starting step 100. If the internal combustion engine 34 is switched off, this is detected by the control unit 58 in a first main step 102 through evaluation of associated engine operating information, which is available at the CAN data bus 74. When the internal combustion engine 34 is switched off (time t=t_0 in FIG. 3) it continues to rotate slightly until it has come to a complete standstill (time t=t_1 in FIG. 3). The hydraulic pump 24 is then likewise at a standstill, so that it no longer delivers hydraulic fluid into the hydraulic system 22. The pressure drop which is then initiated in the hydraulic system 22 provides the basis for a subsequent assessment of the functional state of the hydraulic accumulator 14.

In this regard, it is initially provided in a second main step 104 that, starting with the sensor data provided via the CAN data bus 74 in a first auxiliary step 106, the pressure drop in the hydraulic system 22 is monitored in relation to a jump in the pressure curve X_A, X_B, which is characteristic of reaching a fully relaxed state of the compression means 18, and a hydraulic pressure p_sys corresponding to the jump in the pressure curve X_A, X_B is ascertained in order to calculate a preload pressure p_pre exerted on the diaphragm 38 by the compression means 18 as a result of the resetting effect of the compressible gas, taking the ascertained hydraulic pressure p_sys as a starting point. In a good approximation “p_sys≈p_pre”.

The pressure-drop behaviour and also the position of the jump in the pressure curve X_A, X_B are reproduced in the diagram according to FIG. 3 to represent two different functional states of the hydraulic accumulator 14. The jump in the pressure curve X_A, X_B is distinguished by a characteristic, and therefore easily detectable, kink. If the function of the compression means 18 contained in the hydraulic accumulator 14 is impaired as a result of a degradation of the preload force, this is expressed through a comparatively low hydraulic pressure p_sys in the jump in the pressure curve X_A, X_B. This behaviour is shown in FIG. 3 for a functional state of the hydraulic accumulator 14 (pressure curve A with jump in the pressure curve X_A) and a functionally impaired state of the hydraulic accumulator 14 (pressure curve B with a jump in the pressure curve X_B).

Since the preload force exerted by the pressure means 18, and therefore the position of the jump in the pressure curve X_A, X_B, is temperature-dependent, the hydraulic pressure p_sys corresponding to the jump in the pressure curve X_A, X_B, or the preload pressure p_pre arising directly from this, is converted into a temperature-compensated preload pressure p′_pre of the compression means 18 by the control unit 58 in a third main step 108. The specification of the reference temperature takes place here at a standardized room temperature of 20° C.

Since the current temperature of the compressible gas in the gas chamber 40 of the hydraulic accumulator 24 is generally unknown or can be detected with significant additional effort, the current operating temperature of the hydraulic fluid located in the fluid chamber 20 of the hydraulic accumulator 14 is alternatively used by the control unit 58 to calculate the temperature-compensated preload pressure p′_pre. Starting with the sensor data provided via the CAN data bus 74 in a second auxiliary step 110, this takes place on the basis of the current operating temperature of the hydraulic fluid in the hydraulic system 22 and/or by evaluating the influences on the operating temperature arising from the current external or ambient temperature. The operating temperature of the hydraulic fluid ultimately represents an auxiliary variable here, which permits at least an indirect conclusion with regard to the current temperature of the compressible gas in the gas chamber 40 of the hydraulic accumulator 24. In one example, this equates to the operating temperature of the hydraulic fluid.

It is provided here that, from the plurality of sensor devices 60, 62, 64, 66, 68 which are distributed in the hydraulic system 22 for the purpose of ascertaining the hydraulic pressure p_sys and/or detecting the operating temperature of the hydraulic fluid, the control unit 58 selects or uses those which are spatially nearest to the hydraulic accumulator 14 or the fluid chamber 20 thereof.

In a fourth main step 112, the control unit 58 compares the temperature-compensated preload pressure p′_pre calculated in the third main step 106 with a target value p_pre_soll specified in this regard. The specification of the target value p_pre_soll takes place according to the specifications for a functional state of the compression means 18 and is found in corresponding information provided by the manufacturer of the hydraulic accumulator 14 used. By way of example, this is usually in the order of magnitude of 12 bar.

Depending on the result of the comparison, the method continues with a fifth main step 114 or a sixth main step 116:

If it arises in the fourth main step 112 that the temperature-compensated preload pressure p′_pre calculated in the third main step 108 does not reach the specified target value p_pre_soll, the control unit 58 concludes a malfunction of the hydraulic accumulator 14 and continues with the fifth main step 114. In this, through activation of the user interface 76 or the display 78, the control unit 58 induces the output of driver information indicating a malfunction of the hydraulic accumulator 14 and/or the generation of an input indicating a malfunction of the hydraulic accumulator 14 into a diagnostic system 80.

On the other hand, if the specified target value p_pre_soll is reached, it is assumed that the hydraulic accumulator 14 or the compression means 18 is in a functional state. In this case, the method is terminated in the sixth main step 116.

It should be noted that the use of the proposed method for state-checking is not restricted to an agricultural tractor 10; it may instead relate to agricultural or forestry vehicles of any design, but equally to a construction vehicle or a stationary application.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for checking the state of a hydraulic accumulator having a fluid chamber, which communicates with a hydraulic system supplied with hydraulic fluid from a hydraulic reservoir by a motor-driven hydraulic pump, comprising:
monitoring via a control unit a pressure drop in the hydraulic system in relation to a jump in the pressure curve, which is characteristic of reaching a fully relaxed state of the hydraulic accumulator, when the motor drive of the hydraulic pump is switched off;
ascertaining via the control unit a hydraulic pressure corresponding to the jump in the pressure curve;
calculating via the control unit a preload pressure exerted by the hydraulic accumulator by starting with the ascertained hydraulic pressure; and
concluding via the control unit a malfunction of the hydraulic accumulator when the preload pressure does not reach a specified target value.

2. The method of claim 1, further comprising
converting via the control unit the preload pressure into a temperature-compensated preload pressure of the hydraulic accumulator; and
comparing via the control unit the temperature-compensated preload pressure with the specified target value for assessment of the malfunction of the hydraulic accumulator.

3. The method of claim 2, further comprising:
calculating via the control unit the temperature-compensated preload pressure by using the current operating temperature of the hydraulic fluid located in the fluid chamber of the hydraulic accumulator.

4. The method of claim 3, further comprising:
ascertaining via the control unit the hydraulic pressure and detecting via the control unit the operating temperature of the hydraulic fluid by selecting one or more sensor devices from a plurality of sensor devices distributed in the hydraulic system, the one or more sensor devices spatially nearest to the hydraulic accumulator.

5. The method of claim 1, further comprising:
inducing via the control unit output of driver information indicating the malfunction of the hydraulic accumulator through a user interface.

6. The method of claim 1, further comprising:
generating via the control unit an input indicating the malfunction of the hydraulic accumulator into a diagnostic system.

7. A system for checking the state of a hydraulic accumulator having a fluid chamber, which communicates with a hydraulic system supplied with hydraulic fluid from a hydraulic reservoir by a motor-driven hydraulic pump, comprising:
a control unit configured to:
monitor a pressure drop in the hydraulic system in relation to a jump in the pressure curve, which is characteristic of reaching a fully relaxed state of the hydraulic accumulator, when the motor drive of the hydraulic pump is switched off
ascertain a hydraulic pressure corresponding to the jump in the pressure curve;
calculate a preload pressure exerted by the hydraulic accumulator by starting with the ascertained hydraulic pressure; and
conclude a malfunction of the hydraulic accumulator when the preload pressure does not reach a specified target value.

8. The system of claim 7, wherein the control unit is further configured to:
convert the preload pressure into a temperature-compensated preload pressure of the hydraulic accumulator; and
compare the temperature-compensated preload pressure with the specified target value for assessment of the malfunction of the hydraulic accumulator.

9. The system of claim 8, wherein the control unit is further configured to:
calculate the temperature-compensated preload pressure by using the current operating temperature of the hydraulic fluid located in the fluid chamber of the hydraulic accumulator.

10. The system of claim 9, wherein the control unit is further configured to:
ascertain the hydraulic pressure and detect the operating temperature of the hydraulic fluid by selecting one or more sensor devices from a plurality of sensor devices distributed in the hydraulic system, the one or more sensor devices spatially nearest to the hydraulic accumulator.

11. The system of claim 7, wherein the control unit is further configured to:
induce output of driver information indicating the malfunction of the hydraulic accumulator through a user interface.

12. The system of claim 7, wherein the control unit is further configured to:
generate an input indicating the malfunction of the hydraulic accumulator into a diagnostic system.
